(19) United States
(12) Patent Application Publication
(10) Pub. No.: US 2017/0162074 A1
(43) Pub. Date: Jun. 8, 2017

(54) Method and kit for promoting hand washing in a non-confrontational manner

(71) Applicant: Kelly D. Cheatham, Hoover, AL (US)

(72) Inventor: Kelly D. Cheatham, Hoover, AL (US)

(21) Appl. No.: 15/368,450

(22) Filed: Dec. 2, 2016

Related U.S. Application Data
(60) Provisional application No. 62/262,301, filed on Dec. 2, 2015.

(51) Int. Cl. G09B 19/00

(52) U.S. Cl. CPC G09B 19/0076

(57) ABSTRACT

The invention disclosed is a method and kit for promoting hand washing and proper hand hygiene practices to prevent healthcare associated infections and more specifically a method and kit that a patient can use to help ease the intimidation and fear of asking healthcare workers to wash their hands before administering healthcare services to that patient. The kit would include at least one decal or sticker bearing a word cue, at least one display card bearing a word cue, and at least one bracelet bearing a word cue.

### CROSS-REFERENCE TO RELATED APPLICATIONS

The instant application claims priority to U.S. Provisional Patent Application Ser. No. 62/262,301 filed on Dec. 2, 2015.

### FEDERALLY SPONSORED RESEARCH

None

### SEQUENCE LISTING

None

### FIELD OF THE INVENTION

The invention relates to proper hand hygiene practices to prevent healthcare associated infections and more specifically a kit and method that a patient can use to help ease the intimidation and fear of asking healthcare workers to wash their hands before administering healthcare services to that patient.

### BACKGROUND OF THE INVENTION

Healthcare Associated Infections (herein referred to as “HAI”) are infections that patients get while receiving treatment for unrelated medical or surgical conditions. HAIs kill 99,000 people per year, represent the 4th major cause of death annually in the United States and cost the U.S. healthcare system billions of dollars every year. HAIs are among the leading causes of preventable deaths in the U.S. and are associated with a substantial increase in health care costs each year. Inadequate hand hygiene practices in healthcare settings by healthcare workers contribute towards these HAIs. Hospitals and healthcare settings require healthcare staff to observe and practice proper hand hygiene for patient safety. The World Health Organization describes 5 moments of proper hand hygiene practices that should be observed by healthcare workers when coming in contact with a patient. These 5 moments are before they touch a patient, before clean/aseptic procedures, after body fluid exposure risk, after touching a patient, and after touching patient surroundings. Hand hygiene includes washing their hands for the recommended time using various types of soap and water and/or using various chemical agents that kill bacteria upon contact. However, despite this requirement, healthcare worker hand hygiene compliance averages 35%. To compound the problem, hand hygiene compliance and hospital infection rates do not have to be publicly reported, although it directly impacts patients and their outcomes. Further, some healthcare workers are not held accountable for their lack of hand hygiene performance despite the fact that many patient lives are dependent on their caregivers performing the simple task of cleaning their hands before touching them.

While new technology exists to monitor hand hygiene, it is cost prohibitive, complex and technical. U.S. Patent Application Serial No. 2014/0049391A1 among other things discloses an electronic badge that displays the state of cleanliness of the healthcare worker's hands through various electrical communicating processes. While this system may work it is cost prohibitive and vulnerable to various technical difficulties that may arise. This type of technology is viewed as a ‘want’ and not a ‘need’ and is often first to be cut from hospital budgets because it remains out of the public eye, although patients would certainly see efforts in hand hygiene practices as a ‘need’. Unfortunately, these systems are seen by healthcare workers as intrusive and are most often met with negativity and refusal to participate.

For 150 years, hospitals have tried to get healthcare workers to wash or sanitize their hands before and after touching patients or performing procedures on them. HAIs lead to extended hospital stays averaging eight days in length, which end up costing hospitals billions of dollars each year. Hospitals are now being further financially affected by the Hospital Consumer Assessment of Healthcare Providers and Systems (HCAHPS) survey and are not being reimbursed by Medicare for extended hospital stays, re-admissions and/or procedures resulting from an HAI. Hand hygiene education and/or follow-up questions are often asked at a patient's discharge or after they have gone home through a survey when they are not able to observe hand hygiene behavior. Patients are not involved in hand hygiene efforts from the beginning of care even though the patient is ultimately the one is adversely affected by healthcare workers who do not wash their hands.

While a patient can communicate directly with a healthcare worker and request that they wash or sanitize their hands, many patients are very intimidated by doctors and nurses and cannot work up the nerve to ask them to wash their hands for a variety of reasons. Some of the reasons patients are hesitant to request proper hand washing and sanitization includes fear of hurting the healthcare worker's feelings, projecting the accurate knowledge and conclusion that their hands are unclean, fear of sub-standard care if their request offends the healthcare worker and fear of rejection.

What is needed in the art is a method and kit that puts healthcare professionals on notice each and every time the healthcare professional enters the patient's room, that the patient is aware that they are required to wash their hands while the patient does not have to verbalize such request and therefore does not feel uncomfortable or intimidated by needing to verbally ask them to wash their hands. This is achieved through a simple to apply, patient oriented method and kit for promoting proper hand washing protocol that provides a physical, observable and non-confrontational tool that puts healthcare professionals on notice that they are expected to observe proper hand hygiene practices before administering treatment. The method and kit herein disclosed prompts healthcare workers to wash or sanitize at appropriate times. Specific advantages and features of the present assembly will be apparent from the accompanying drawings and the description of several illustrative embodiments of the present invention.

### SUMMARY OF THE INVENTION

The invention herein disclosed is a method and kit comprised of a word cue related to hand washing that is placed on various items within close proximity to a patient treatment area and the patient themselves. The word cue can be a single word, a phrase, a full sentence, or a sentence in the form of a question used to influence the healthcare professional to follow proper hand hygiene practices. The word cue will have some direct relation to the promotion of proper hand hygiene practices and that the patient desires those healthcare workers that are attendant to them to observe these practices. The word cue should also have inherent directness and force in its meaning so that there is little question what the patient desires from the healthcare worker. In one embodiment, the word WASHMIND can be used as a word cue. WASHMIND can have more than one meaning but it is generally meant to be defined as “respect and mind the wishes of the patient to observe proper and safe hand hygiene practices.” Another alternative connotation or meaning a viewer might attach to WASHMIND “to be mindful to always wash your hands” before encountering a patient. In another embodiment, a phrase or question such as “Will you wash your hands?” or “Would you mind cleaning your hands?” or “Thanks for washing your hands!” can be utilized to promote proper hand hygiene visibly for a patient without needing to ask the question verbally.

The items and method used to display this word cue comprise at least one decal or sticker, a display card, and at least one bracelet to be worn by the patient. The word cue is displayed by the placement of these items on the following: a two-sided vinyl static cling decal for placement on a patient's glass window, door or other suitable area chosen by a patient in their room, one or more bracelets worn by a patient on their wrist(s) or ankle(s), and a display card with relevant HAI information and hand washing protocol located thereon and used to serve as a reminder tool that a patient and their family can reference to educate them on when a healthcare worker needs to perform hand hygiene practices that will protect them from germs that may have been brought into their room on a healthcare workers hands.

The two-sided cling decals will have the word cue upon them and will be placed either on the door or glass window of a patient's room or other suitable surfaces visible to a healthcare worker. On a glass surface, the two-sided decals will be visible both outside and inside the room. The decals will place the health professional on notice even before entering the room that the patient is asking for and desiring that proper hand hygiene practices are followed. These decals can also be placed inside the patient's room as well as on various surfaces as chosen by a patient. The static cling feature of the decal allows a patient to move, remove or reuse without leaving any residue that a sticker may leave. The decals can be black and white decals so as not to avoid confusion with other color coded stickers used in hospitals.

The display card will have the word cue WASHMIND, or other suitable word cue(s), printed upon it in large letters along with hand washing tips, facts and moments to watch for to ensure the patient is protecting themselves from germs being brought into their room on a healthcare worker's hands. The card will be placed on a bedside table nearby the patient so as to be visible to healthcare workers when attending to the patient and their family. The card is made of rigid material such as flexible plastic, cardstock or corrugated cardboard. In one embodiment the card will be rectangular in shape with an upper fold line, a middle fold line, and a lower fold line. The card is folded in an inward direction along the upper, middle and lower fold lines to create a triangular shaped tent display card. The portion of the card above the upper fold line contains a slot adapted to receive a tongue located in the card under the lower fold line for purposes of completing the connection of the display card.

The bracelet serves the dual purpose of reminding healthcare workers of proper hand hygiene practices inside the patient's room and also if a patient is temporarily removed from their hospital room for various forms of treatment such as x-rays, MRIs or other medical tests. The bracelet bearing the word cue WASHMIND or other suitable word cue or phrase serves as a portable reminder to healthcare workers to follow proper hand hygiene practices. In one embodiment, the bracelet is made of silicone and will have the word cue embossed upon its exterior surface or formed into is surface and may be made of or have incorporated into the bracelet phosphorescent materials that cause the bracelet to glow in the dark.

In addition to saving countless patient lives and reducing extended sicknesses, patients and hospitals stand to benefit a great deal with the disclosed method and kit. Given that the cost of the method and kit is minimal and the use of the method and kit is simple and non-technical, hospital executives can simultaneously increase hand hygiene by their workers resulting in a possible decrease in HAIs and reduced length of hospital stays while raising hospital revenue. A low cost and easy to use method and kit could benefit patients by empowering them to help ensure they are treated with clean hands and allowing them to participate and ensure a positive outcome. By adoption of the disclosed method and kit, patients can positively impact their outcomes by promoting increased hand hygiene resulting in a decreased chance of acquiring an HAI, while removing the barrier of fear to ask healthcare workers to wash their hands.

### BRIEF DESCRIPTION OF THE DRAWINGS

FIG. 1 is a side view of a hospital room door and window.

FIG. 2 is a perspective view of a bracelet.

FIG. 3 is a perspective view of a decal.

FIG. 4 is a perspective view of a deployed card display

FIG. 5 is a top plan view of a card undeployed.

### DETAILED DESCRIPTION

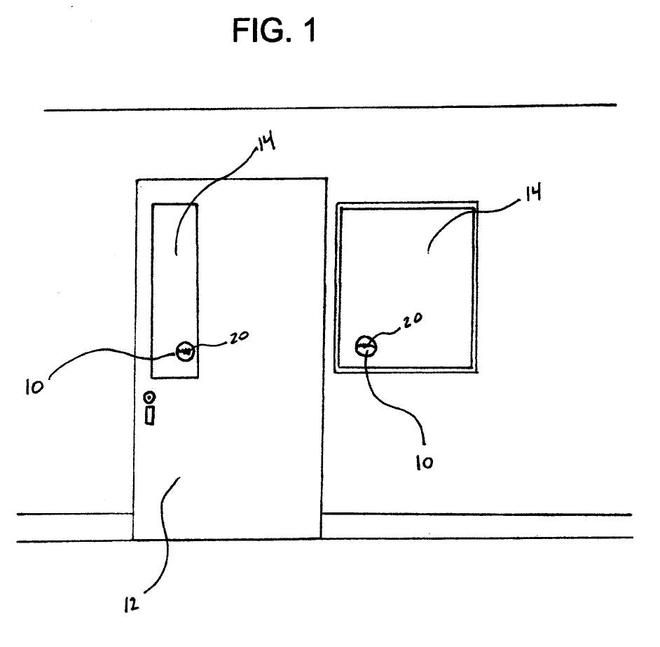

The invention is generally depicted in FIGS. 1-11 but may be embodied in various other forms. The principles and teachings of the invention, therefore, can be applied to numerous alternative variations.

Referring now to FIG. 1, therein is disclosed the placement of double sided vinyl cling decals 10 onto a door 12 window 14 and a window 14 located on a wall on the outside of a hospital room. Healthcare workers will be able to see the decals 10 and read the word cue 20 which puts them on notice to observe proper hand hygiene practices. The word cue 20 can be any single word, phrase, sentence or question that is related and relevant to proper hand washing in a medical facility. Not only are the decals 10 visible outside of the hospital room, they are also visible from the inside of the room due to the decal 10 having the word cue on both sides of the decal 10 such that the decal 10 is double sided. As many decals 10 as practically possible can be placed on the window's surface. The decals 10 can also be placed on other surfaces inside the room regardless if both sides of the decal 10 are visible. The patient or patient's family or friends can place the decals 10 for display. The decals 10 can have incorporated into them phosphorescent material such that the decals 10 glow in the dark so that a healthcare worker will see them upon entering a dim or darkened patient room. The decals 10 can also be colored black and white to avoid confusion with other color coded stickers or decals 10 located in a hospital and would further promote the use of phosphorescent material in their composition. In addition, stickers 10 bearing the word cue 20 could be used to be placed on a hospital gown of a patient.

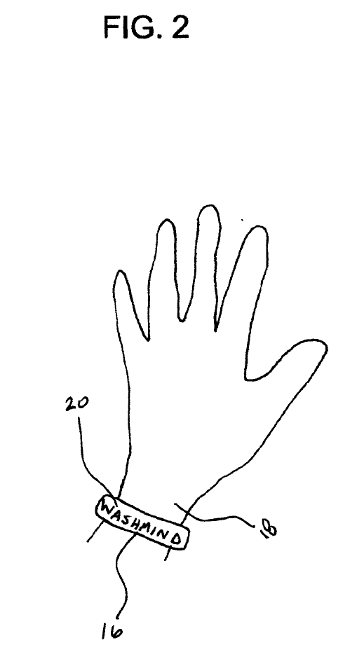

Referring now to FIG.2, therein is disclosed a bracelet 16 worn on a patient's wrist 18 with a word cue 20 embossed onto its exterior surface. The word cue 20 in one embodiment can be the word WASHMIND. The bracelet 16 serves to place healthcare workers on notice that proper hand hygiene practices are expected by the patient. The bracelet 16 can be considered the last line of defense since it will be the last word cue 20 reminder that a healthcare worker sees before making contact with the patient. A bracelet 16 can and should be worn on both of a patient's wrists 18 and also ankles to further remind a healthcare worker in case the healthcare worker approaches a patient from a different direction. Additionally, the bracelet 16 serves as a portable reminder should the patient have to be temporarily moved to another part of a medical facility for various tests and treatments. In one embodiment, the bracelet 16 can be made of silicone, but any other number of materials such as cloth, leather, plastic, rubber, wood or metal could be used. The word cue 20 can be of any color, but brighter, bolder colors that stand out are preferred. In addition, the bracelet 16 can be formed of phosphorescent material or have phosphorescent material incorporated therein such that the word cue 20 is visible to a healthcare worker in low light situations.

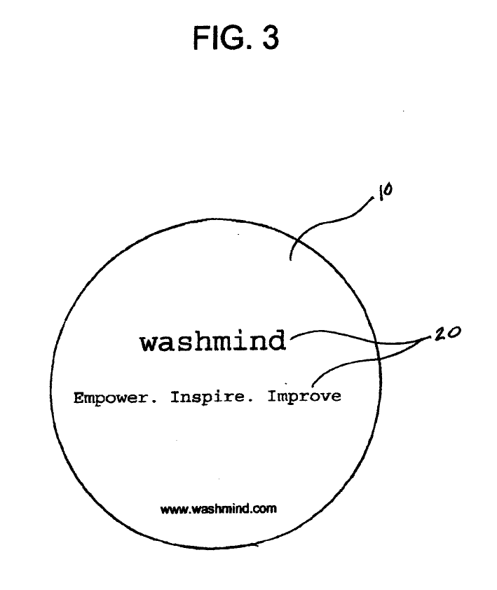

Referring now to FIG. 3, therein is disclosed a double sided vinyl cling decal 10 with the word cue 20 WASHMIND located thereon. Other word cues 20 such as the phrase or question “Will you wash your hands?” may be used. Any word cue 20 that promotes proper hand hygiene can be used. The decals 10 can be placed on doors 12 and windows 14 and other areas in the room. The double sided vinyl cling decal 10 allows for use both on a transparent surface such as a window so that both sides can be seen as well as on a non-transparent surface such as a cabinet, drawer or wall. The static cling feature of the decal 10 allows for a patient to move the decals 10 to different places or to easily take them down without leaving any residue that a sticker might leave.

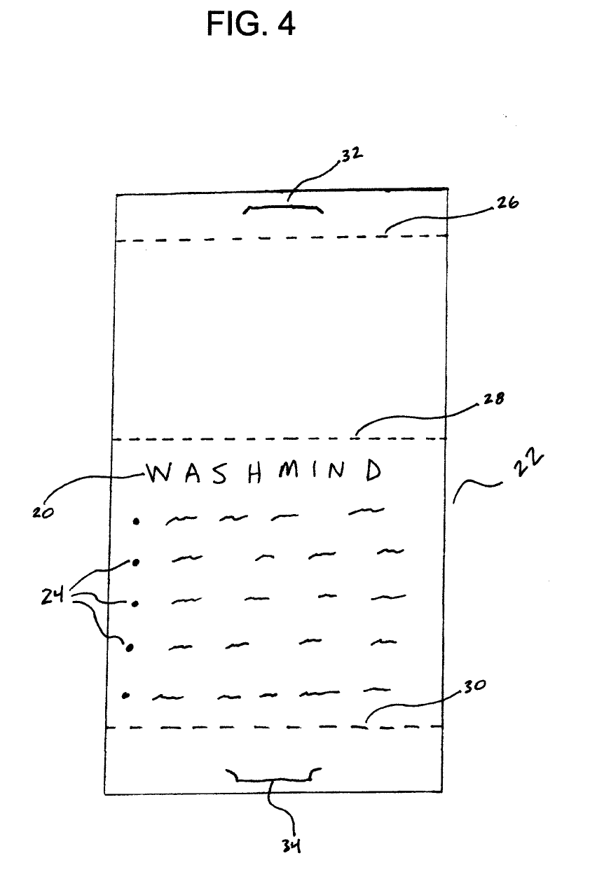

Referring now to FIG. 4, therein is disclosed a display card 22 in an un-deployed state with a word cue 20 located thereon, tips, facts and when to wash 24 regarding proper hand hygiene practices, a top fold line 26, a central fold line 28 a lower fold line 30 a slot 32 and a tongue 34. In one embodiment, a patient will take the 22 display card and fold along the upper fold line 26, the central fold line 28 and the lower fold line 30 so that the card is in the shape of a triangular tent with the word cue 20 facing outwards to be seen by a healthcare worker. The tongue 34 will be inserted into the slot 32 to complete the card so that it stands on a base. The display card 22 can be placed on a bedside table or other work surface in a patient's hospital room. More than one display card 22 can be placed in a hospital room to ensure that healthcare workers see them. The display card 22 is made of a sturdy material such as plastic, cardstock, or corrugated cardboard. In an alternate embodiment, the display card 22 can be a flat to lay on a flat horizontal surface visible to a healthcare worker.

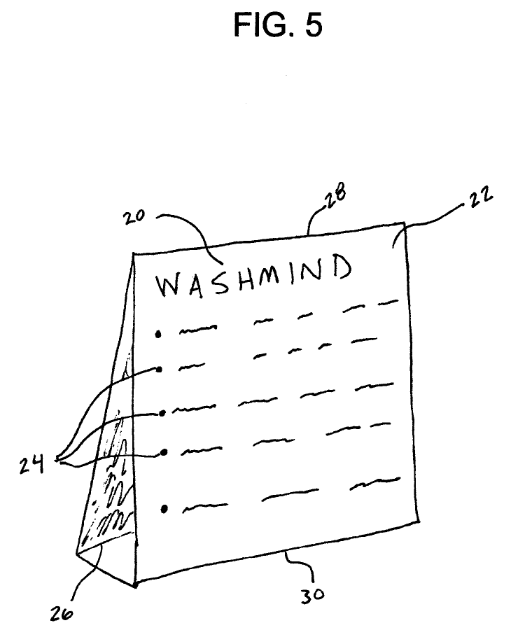

Referring now to FIG. 5, therein disclosed is a deployed display card 22 ready for placement on an appropriate surface in a patient's room.

Used together, the decals 10, bracelet 14 and card 22 as shown in FIGS. 1-5 can be provided to patients as a kit with instructions given on the placement thereof. This kit and method provides a patient with a voice regarding their care and specifically encourages healthcare workers to follow proper hand hygiene practices without the patient having to verbalize a request for the healthcare workers to wash their hands.

The principles, embodiments, and modes of operation of the present invention have been set forth in the foregoing specification. The embodiments disclosed herein should be interpreted as illustrating the present invention and not as restricting it. The foregoing disclosure is not intended to limit the range of equivalent structure available to a person of ordinary skill in the art in any way, but rather to expand the range of equivalent structures in ways not previously contemplated. Numerous variations and changes can be made to the foregoing illustrative embodiments without departing from the scope and spirit of the present invention.

The invention claimed is:

1. A handwashing kit comprising:
at least one decal;
at least one display card; and
at least one bracelet.

2. The handwashing kit of claim 1 wherein a word cue is displayed upon the decal, display card and bracelet.

3. The handwashing kit of claim 2 wherein the word cue is related to hand washing.

4. The handwashing kit of claim 3 wherein the word cue is selected from the group consisting of a single word, a phrase, a sentence or a question.

5. The handwashing kit of claim 1 wherein the display card has relevant written information related to hand washing and healthcare associated infections.

6. The handwashing kit of claim 1 wherein the decal is two sided and has static cling properties.

7. The handwashing kit of claim 1 wherein the bracelet and decal are made of phosphorescent materials or have phosphorescent materials on their surface.

8. The handwashing kit of claim 1 wherein the decal, display card and bracelet are black and white in color.

9. The handwashing kit of claim 1 wherein the display card is a tent card made to be assembled and displayed in an upright position on a horizontal surface.

10. The handwashing kit of claim 1 further comprising stickers bearing the word cue that are wearable by a patient on their hospital garments.

11. A method for preventing the transfer of healthcare associated infections comprising the steps of:
providing a patient with a handwashing kit further comprising at least one decal, at least one display card, and at least one bracelet wherein the decal, display card, and bracelet have located on a visible surface a word cue related to the washing of ones hands;
placing at least one decal on a surface that is visible to a healthcare worker;
placing said display card such that is visible to a healthcare worker;
wearing at least one bracelet on a patients arm; and
wearing at least one bracelet on a patient's ankle.

12. The method of claim 11 further comprising the step of forming a portion of the bracelet and decal out of phosphorescent materials.

13. The method of claim 11 wherein the decal is double sided such that it displays the word cue on both sides and is formed of static cling materials.

14. The method of claim 11 further comprising the step of placing a decal on either the interior or exterior of a hospital room door window or window such that it is visible from either side to a healthcare worker.

15. The method of claim 11 further comprising the step of forming the bracelets and decals out of black and white materials whereby the white materials would have phosphorescent materials included therein.

16. The method of claim 11 further comprising the step of including relevant information important to the topic of healthcare associated infections and hand washing on the display card.

17. The method of claim 11 further comprising the step of forming the display card to be a free standing tent card.

18. The method of claim 11 further comprising stickers bearing the word cue that are wearable by a patient on their hospital garments.
